(19) United States
(12) Patent Application Publication
(10) Pub. No.: US 2007/0076164 A1
(43) Pub. Date: Apr. 5, 2007

(54) Eyewear accessory

(76) Inventor: Chihan Kim, Sandy, UT (US)

Correspondence Address: KARL R CANNON, PO BOX 1909, SANDY, UT, 84091, US

(21) Appl. No.: 11/400,046

(22) Filed: Apr. 7, 2006

Related U.S. Application Data
(63) Continuation-in-part of application No. 29/238,111, filed on Sep. 9, 2005.
(60) Provisional application No. 60/725,247, filed on Oct. 10, 2005.
(60) Provisional application No. 60/737,590, filed on Nov. 16, 2005.

(51) Int. Cl. G02C 9/00

(52) U.S. Cl. 351/47

(57) ABSTRACT

An apparatus and method of joining auxiliary eyewear to eyewear is disclosed. The eyewear may be in the form of eyeglasses and may include a support attached on each side of temple portions of the eyewear. Each support may include a magnet and may define a slot for receiving a tab on the auxiliary eyewear. The tab on the auxiliary eyewear may also include a magnet for being connected to the magnet on the support. The tabs may be connected to the auxiliary eyewear through arms. The auxiliary eyewear may be attached to the eyewear from above the supports or from below the supports by inserting the tabs into the slots defined by the supports. The auxiliary eyewear may be held securely in place during use and the auxiliary eyewear may be removed from the eyewear by withdrawing the tabs from the slots.

### CROSS-REFERENCE TO RELATED APPLICATIONS

This application is a continuation-in-part of co-pending U.S. Design Patent Application No. 29/238,111, filed Sep. 9, 2005, entitled “Eyewear Connector.” This application also claims the benefit of U.S. Provisional Application No. 60/725,247, filed Oct. 10, 2005, entitled “Eyewear Accessory,” and U.S. Provisional Application No. 60/737,590, filed Nov. 16, 2005, entitled “Eyewear Accessory,” all of which applications are hereby incorporated by reference herein in their entireties, including but not limited to those portions that specifically appear hereinafter, the incorporation by reference being made with the following exception: In the event that any portion of the above-referenced applications is inconsistent with this application, this application supercedes said above-referenced applications.

### STATEMENT REGARDING FEDERALLY SPONSORED RESEARCH OR DEVELOPMENT

Not Applicable.

### BACKGROUND

1. The Field of the Invention

The present disclosure relates generally to eyewear, and more particularly, but not necessarily entirely, to eyewear and auxiliary eyewear that are configured to be joined together.

2. Description of Related Art

It is common practice to provide auxiliary frames for eyeglasses. An auxiliary frame may provide shaded lenses for the eyeglasses or other beneficial lenses, such as magnifying lenses. In the past, auxiliary frames primarily included two different styles. The first style are those auxiliary frames that were held rigidly in place over the lenses of the eyeglasses. The second type are those auxiliary frames that can be “flipped up” with respect to the lenses of the eyeglasses.

In practice, various methods have been employed for attaching the auxiliary frames to the eyeglasses. The traditional method used one or more mechanical clips to attach the auxiliary frames. Recently, clips have fallen into disfavor among consumers. Disadvantageously, clipped-on auxiliary frames are often difficult to use and in many instances required two hands of a user to attach or remove the auxiliary frames. Further, clips are often bulky and unsightly when employed on auxiliary frames made for more expensive, higher-end eyeglasses. Another drawback to the use of clips to attach auxiliary frames is that the clips themselves also have a tendency to scratch or otherwise damage the lenses or frames of the eyeglasses.

Some attempts have been made to eliminate the use of clips to attach auxiliary frames to the eyeglasses. Some of these attempts have included the use of magnets to attach the auxiliary frames to the eyeglasses.

The previously known devices are characterized by several disadvantages that are addressed by the present disclosure. The present disclosure minimizes, and in some aspects eliminates, the above-mentioned failures, and other problems, by utilizing the methods and structural features described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is an exploded perspective view of a pair of eyewear and a pair of auxiliary eyewear;

FIG. 2 is a perspective view of the eyewear and auxiliary eyewear of FIG. 1, in which the eyewear and auxiliary eyewear are joined together;

FIG. 3 is a break-away rear perspective view of a connection between the eyewear and the auxiliary eyewear;

FIG. 4 is a break-away front perspective view of a connection between the eyewear and the auxiliary eyewear;

FIG. 5 is a break-away interior side perspective view of a connection between the eyewear and the auxiliary eyewear;

FIG. 6 is a break-away exterior side perspective view of a connection between the eyewear and the auxiliary eyewear;

FIG. 7 is a break-away top view of a connection between the eyewear and the auxiliary eyewear;

FIG. 8 is a break-away bottom view of a connection between the eyewear and the auxiliary eyewear;

FIG. 9 is a break-away front view of a connection between the eyewear and the auxiliary eyewear;

FIG. 10 is a break-away rear view of a connection between the eyewear and the auxiliary eyewear;

FIG. 11 is a break-away perspective view of a connection between the eyewear and the auxiliary eyewear in which the auxiliary eyewear is attached from beneath;

FIG. 12 is a perspective view of an alternative embodiment connection between the eyewear and the auxiliary eyewear, in which the auxiliary eyewear, is attached from beneath;

FIG. 13 is a perspective view of an alternative embodiment connection between the eyewear and the auxiliary eyewear, in which the auxiliary eyewear is attached from above;

FIG. 14 is a perspective view of a portion of an alternative embodiment eyewear;

FIG. 15 is a break-away perspective view of an alternative embodiment connection between the eyewear and the auxiliary eyewear, in which the auxiliary eyewear is attached from beneath;

FIG. 16 is a break-away perspective view of an alternative embodiment connection between the eyewear and the auxiliary eyewear, in which the auxiliary eyewear is attached from above;

FIG. 17 is an exploded break-away perspective view of an alternative embodiment connection between the eyewear and the auxiliary eyewear, in which the auxiliary eyewear is attachable to a side of a support;

FIG. 18 is another exploded break-away perspective view of the alternative embodiment connection between the eyewear and the auxiliary eyewear as shown in FIG. 17;

FIG. 19 is a break-away perspective view of the alternative embodiment connection between the eyewear and the auxiliary eyewear of FIGS. 17 and 18, in which the auxiliary eyewear is attached to the eyewear;

FIG. 20 is an exploded break-away perspective view of another alternative embodiment connection between the eyewear and the auxiliary eyewear, in which the auxiliary eyewear is attachable to a side of a support;

FIG. 21 is a break-away perspective view of the alternative embodiment connection between the eyewear and the auxiliary eyewear of FIG. 20, in which the auxiliary eyewear is attached to the eyewear;

FIG. 22 is an exploded break-away perspective view of another alternative embodiment connection between the eyewear and the auxiliary eyewear, in which the auxiliary eyewear is attachable to a side of a support;

FIG. 23 is a break-away perspective view of the alternative embodiment connection between the eyewear and the auxiliary eyewear of FIG. 22, in which the auxiliary eyewear is attached to the eyewear;

FIG. 24 is an exploded break-away perspective view of another alternative embodiment connection between the eyewear and the auxiliary eyewear, in which the auxiliary eyewear is attachable to a side of a support;

FIG. 25 is a break-away perspective view of the alternative embodiment connection between the eyewear and the auxiliary eyewear of FIG. 24, in which the auxiliary eyewear is attached to the eyewear;

FIG. 26 is another break-away perspective view of the alternative embodiment connection between the eyewear and the auxiliary eyewear as shown in FIG. 13;

FIG. 27 is a front view of the embodiment of FIG. 26;

FIG. 28 is a rear view of the embodiment of FIG. 26;

FIG. 29 is a right side view of the embodiment of FIG. 26;

FIG. 30 is a left side view of the embodiment of FIG. 26;

FIG. 31 is a top view of the embodiment of FIG. 26;

FIG. 32 is a bottom view of the embodiment of FIG. 26;

FIG. 33 is a perspective view of another alternative embodiment of the connection between the eyewear and the auxiliary eyewear of FIG. 26 in which a magnet perimeter is shown in broken lines;

FIG. 34 is a front view of the embodiment of FIG. 33;

FIG. 35 is a rear view of the embodiment of FIG. 33;

FIG. 36 is a right side view of the embodiment of FIG. 33;

FIG. 37 is a left side view of the embodiment of FIG. 33;

FIG. 38 is a top view of the embodiment of FIG. 33;

FIG. 39 is a bottom view of the embodiment of FIG. 33;

FIG. 40 is a exploded, break-away perspective view of an additional alternative embodiment connection between the eyewear and the auxiliary eyewear;

FIG. 41 is a break-away perspective view of the alternative embodiment of FIG. 40 with the auxiliary eyewear joined to the eyewear;

FIG. 42 is an exploded perspective view of the adjustable connection of FIG. 40;

FIG. 43 is an exploded side view of the adjustable connection of FIG. 42;

FIG. 44 is an exploded top view of the adjustable connection of FIG. 42;

FIG. 45 is a perspective view of a housing of the adjustable connection of FIG. 42;

FIG. 46 is a cross-sectional perspective view of the housing of FIG. 45 taken along line A-A;

FIG. 47 is a perspective view of a biasing member of the adjustable connection of FIG. 42, in a relaxed condition;

FIG. 48 is a perspective view of the biasing member of the adjustable connection of FIG. 42, in a compressed condition;

FIG. 49 is a break-away perspective view of opposing adjustable connections in a raised position;

FIG. 50 is a exploded, break-away perspective view of another alternative embodiment connection between the eyewear and the auxiliary eyewear;

FIG. 51 is a break-away perspective view of the alternative embodiment of FIG. 50 with the auxiliary eyewear joined to the eyewear;

FIG. 52 is a break-away perspective view of an alternative embodiment auxiliary eyewear joined to eyewear in which an arm extends from a side of the auxiliary eyewear frame;

FIG. 53 is a front view of an alternative embodiment auxiliary eyewear;

FIG. 54 is a top view of the alternative embodiment auxiliary eyewear of FIG. 53;

FIG. 55 is a front view of an alternative embodiment eyewear corresponding to the auxiliary eyewear of FIG. 53;

FIG. 56 is a breakaway top view of the eyewear of FIG. 55;

FIG. 57 is a side view of the eyewear of FIG. 55;

FIG. 58 is a front view of the alternative embodiment auxiliary eyewear of FIG. 53 joined with the eyewear of FIG. 55;

FIG. 59 is a breakaway top view of the auxiliary eyewear and eyewear of FIG. 58; and

FIG. 60 is a side view of the auxiliary eyewear and eyewear of FIG. 58.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the present eyewear apparatus and methods are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present disclosure will be limited only by claims to be supplied in the future, and equivalents thereof.

It must be noted that, as used in this specification and the appended claims, the singular forms “a,” “an,” and “the” include plural referents unless the context clearly dictates otherwise. Also, as used herein, the terms “comprising,” “including,” “containing,” “characterized by,” and grammatical equivalents thereof are inclusive or open-ended terms that do not exclude additional, unrecited elements or method steps.

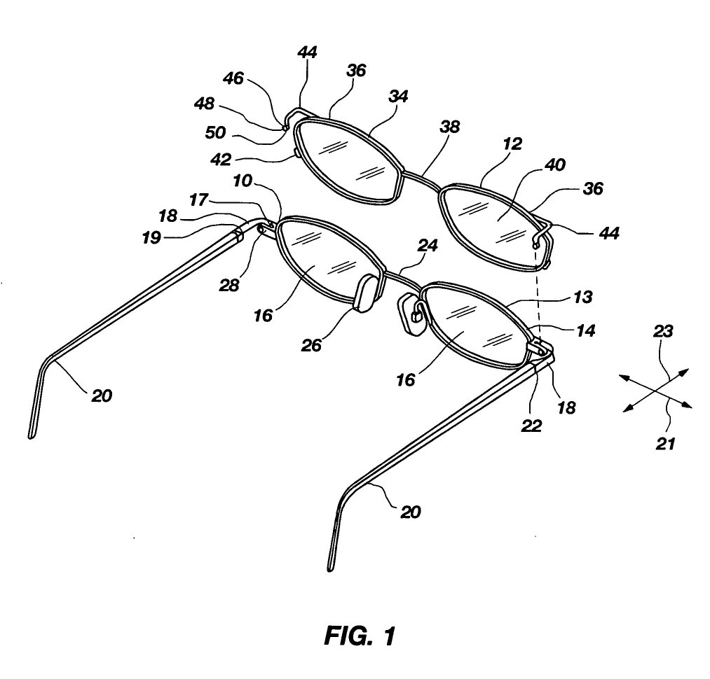

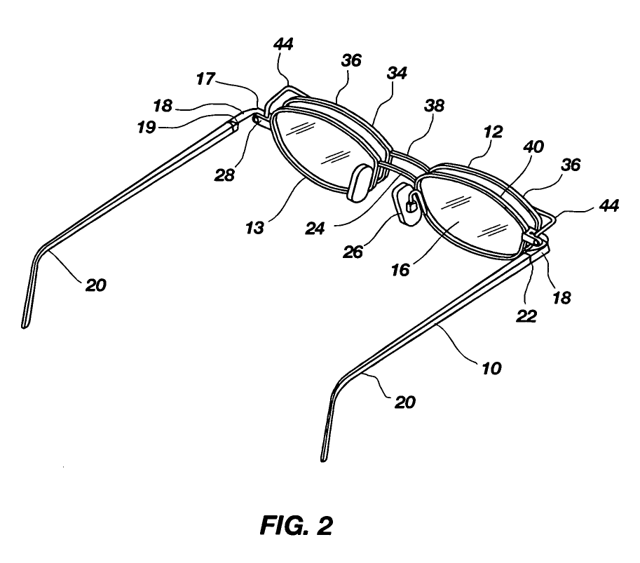

Referring now to FIG. 1, an exploded perspective view is shown of one embodiment of a pair of eyewear 10 and a pair of auxiliary eyewear 12. The eyewear 10 and auxiliary eyewear 12 may have various different configurations and styles and may be configured to be joined together as shown most clearly in FIG. 2. The eyewear 10 may include a frame 13 having a pair of lens receptacles 14 each of which may contain a lens 16. Lenses 16 may be common prescription lenses or the like, or non-prescription lenses. Mounted on the sides of each of the lens receptacles 14 may be a temple extension 18. The temple extension 18 may include a first portion 17 extending in a lateral direction, indicated by arrow 21, with respect to the lens receptacles 14. Accordingly, the first portion 17 of the temple extension 18 may extend in a direction substantially parallel to or aligned with the lens receptacles 14. The temple extension 18 may also include a second portion 19 that may extend in a direction transverse to the first portion 17 in a front to back direction, indicated by arrow 23, with respect to the eyewear 10. Thus, the temple extension 18 may include a turn, corner or bend between the first portion 17 and the second portion 19. An ear piece 20 may be mounted by a hinge assembly 22 on each of the temple extensions 18 at the end of the second portion 19. As is customary in eyewear, the ear pieces 20 may be pivotally operable between a closed position and a ready-to-use position. Some embodiments of the ear pieces 20 may be curved downwardly at the rear portion and other embodiments of the ear pieces 20 may be substantially straight in a configuration known to those skilled in the art.

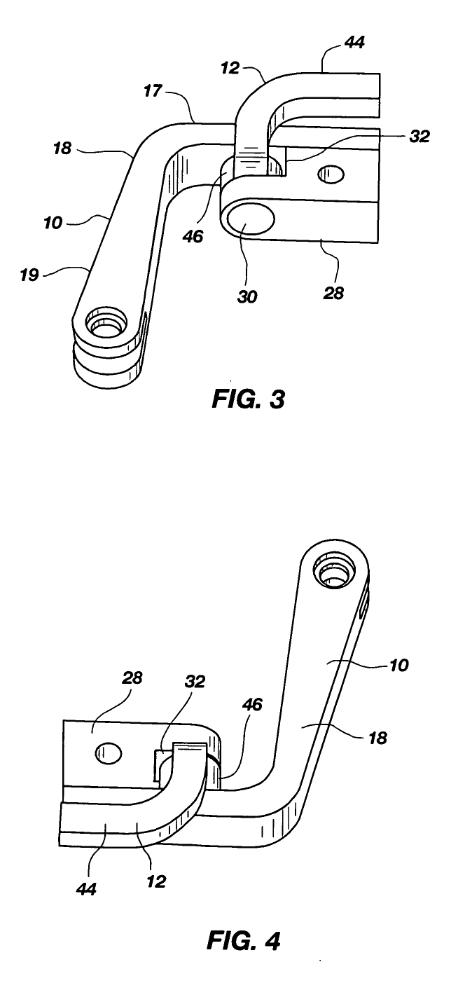

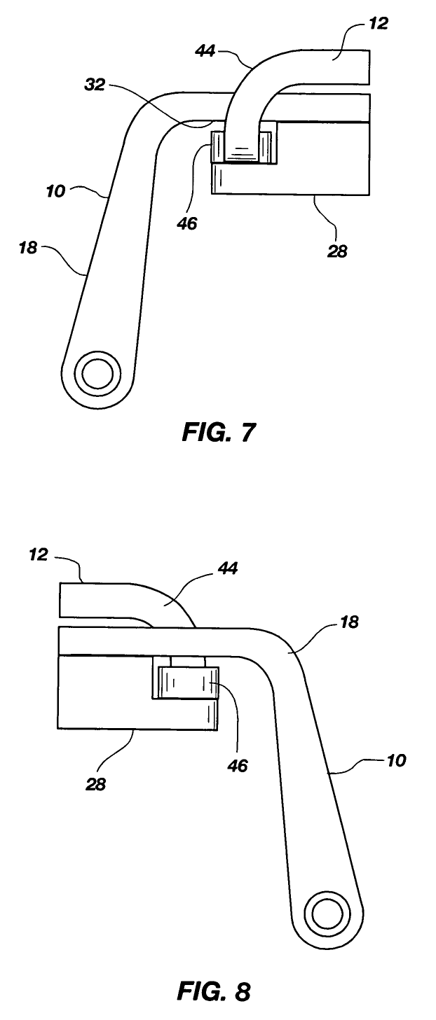

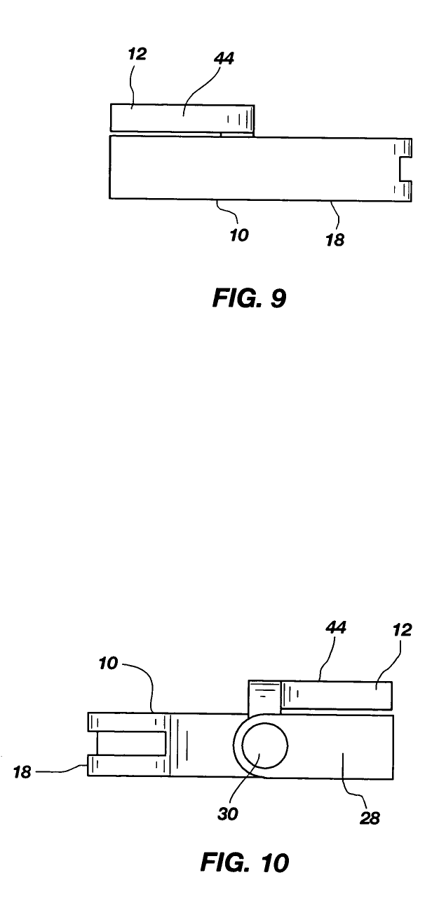

A bridge 24 may extend between the two lens receptacles 14, and the eyewear 10 may include nose pads 26 as is known in the art. The eyewear 10 may also include supports 28 on opposing sides for supporting the auxiliary eyewear 12. The supports 28 may be joined with the temple extensions 18 in any manner known to those skilled in the art. The supports 28 may also include a magnet 30, as best shown in FIG. 3, to allow a more secure connection between the eyewear 10 and the auxiliary eyewear 12. It will be appreciated that alternative embodiments of the supports 28 may not include magnets. Some embodiments may include supports 28 formed of a metallic material that may be attracted by magnets. It will also be understood that various different enlarged views of the supports 28 for forming a connection between the eyewear 10 and auxiliary eyewear 12 are shown in FIGS. 3-10. The supports 28 may also include or define a slot 32 for receiving a portion of the auxiliary eyewear 12 when the auxiliary eyewear 12 are attached to the eyewear 10.

The auxiliary eyewear 12 may include an auxiliary frame 34 comprising a pair of auxiliary lens receptacles 36 connected together by an auxiliary bridge 38. An auxiliary lens 40 may be disposed in each auxiliary lens receptacle 36. The auxiliary lenses 40 may be tinted or polarized, for example, or any other variety of lenses depending on the needs of the user. It will be appreciated by those skilled in the art that auxiliary lenses 40 may have any feature or characteristic now known or known in the future.

Protrusions 42 may be disposed on outer edges of each auxiliary lens receptacle 36. The protrusions 42 may be used for receiving fasteners, such as screws or bolts, for example, for tightening the auxiliary lenses 40 within the frame 34. It will be understood, however, that any other system known in the art may be utilized to attach the auxiliary lenses 40 to the auxiliary frame 34.

The auxiliary frame 34 may also include a pair of arms 44 that may be attached on opposing sides corresponding to the location of the temple extension 18 of the eyewear 10. Each arm 44 may extend in a substantially rearward direction, and may turn in a downward direction. A terminal end piece 46, which may be referred to herein as tab 46 with no intended limitation of the scope of meaning of that feature, may be disposed on each of the arms 44. Each tab 46 may contain one of a pair of auxiliary magnets 48. It will be understood that the tab 46 may be integral with the arms 44, or the tab 46 may be joined to the arms 44. Moreover, other embodiments may not include any magnets in the tab 46 such that the tab 46 may be formed as a solid member or a hollow member. One embodiment of the tab 46 may include a socket 50 for receiving the auxiliary magnets 48. It will be understood that the socket 50 and the auxiliary magnets 48 may be cylindrical in shape or any other suitable shape known to those skilled in the art. The tabs 46 may define an opening leading into the socket 50. An auxiliary magnet 48 may be slidably inserted into the socket 50 through the opening. The auxiliary magnet 48 may be held in the socket 50 by friction, adhesives, or any other attachment mechanism known to those skilled in the art.

In use, the tabs 46 may be placed into the slots 32 and the magnets 30 and/or auxiliary magnets 48 may be attracted together to join the tabs 46 to the supports 28 and to prevent the auxiliary eyewear 12 from moving upwardly or forward with respect to the eyewear 10. The arms 44 may contact the temple extensions 18 to prevent the auxiliary eyewear 12 from moving downwardly with respect to the eyewear 10. Moreover, contact between the supports 28 and the tab 46 may prevent the auxiliary eyewear 12 from moving rearwardly with respect to the eyewear 10. When removing the auxiliary eyewear 12 from the eyewear 10, the auxiliary eyewear 12 may be lifted to overcome the attractive forces of the magnets 30 and/or the auxiliary magnets 48 and thereby allow the tabs 46 to be removed from the slots 32 such that the auxiliary eyewear 12 can be separated from the eyewear 10.

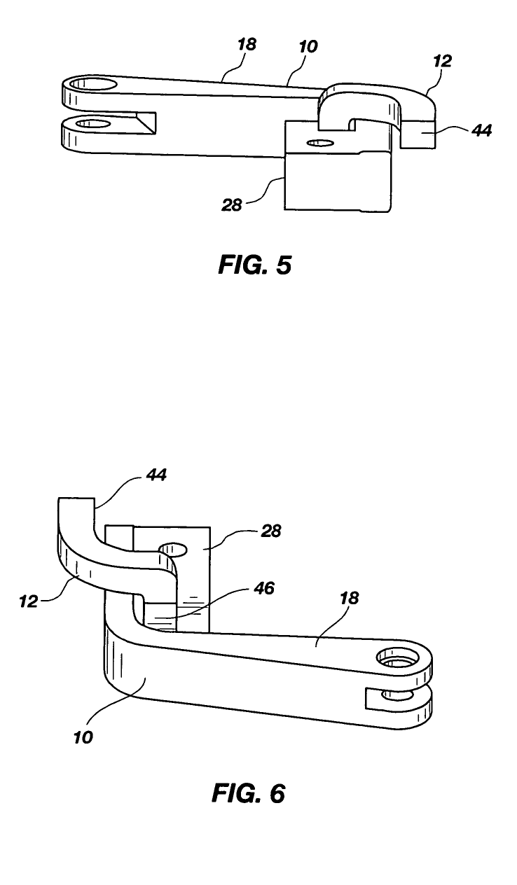

It will be understood that in one embodiment of the present disclosure, the arms 44 may include a polygonal cross-sectional configuration. This configuration is shown most clearly in FIG. 5, in which the arm 44 has a substantially square cross-sectional shape. Such polygonal configuration may facilitate joining the auxiliary eyewear 12 with the eyewear 10, and may also provide a stable connection. It will be understood, however, that other embodiments of the present disclosure may have arms having a rounded or other shaped cross-sectional configuration.

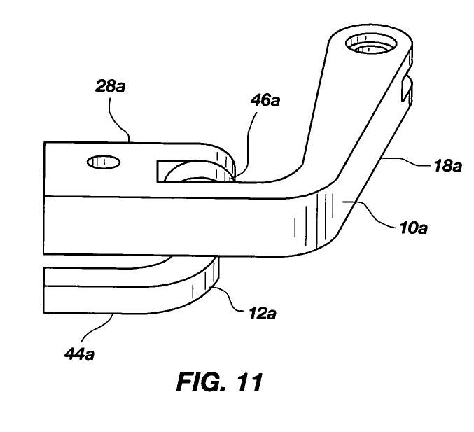

Reference will now be made to FIG. 11 to describe an alternative embodiment of the present disclosure. As previously discussed, the presently disclosed embodiments of the disclosure illustrated herein are merely exemplary of the possible embodiments of the disclosure, including that illustrated in FIG. 11.

It will be appreciated that the alternative embodiment of the disclosure illustrated in FIG. 11 may contain many of the same structures represented in FIGS. 1-10 and only the new or different structures will be explained to most succinctly explain the features which come with the embodiments of the disclosure illustrated in FIG. 11.

FIG. 11 illustrates a perspective view of an alternative embodiment auxiliary eyewear 12a which attaches to the eyewear 10a from below rather than above as in the previously disclosed embodiment. The alternative embodiment disclosed in FIG. 11 may facilitate joining and removing the auxiliary eyewear 12a from the eyewear 10a in some situations.

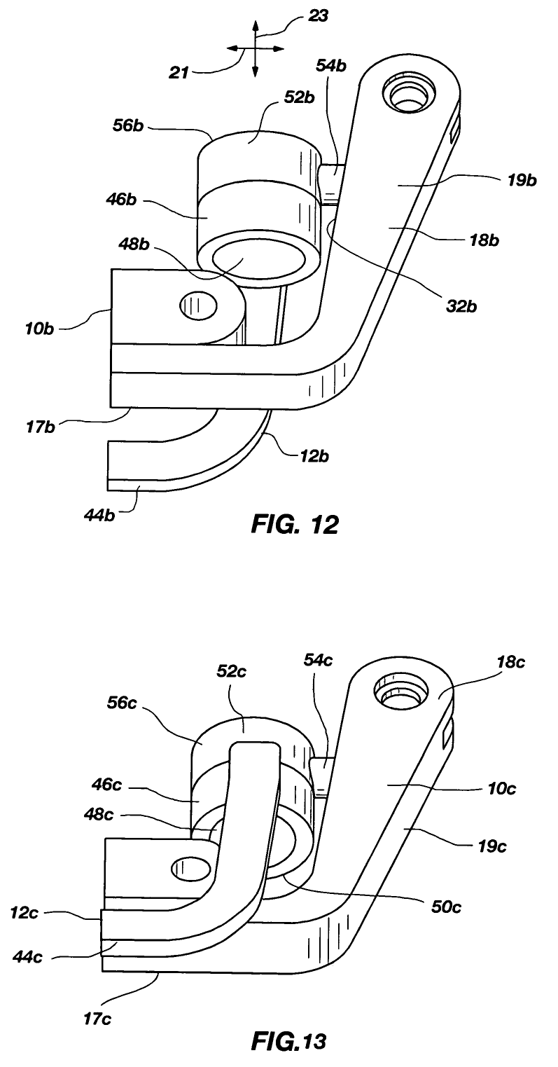

Reference will now be made to FIGS. 12-13 to describe additional alternative embodiments of the present disclosure. As previously discussed, the presently disclosed embodiments of the disclosure illustrated herein are merely exemplary of the possible embodiments of the disclosure, including those illustrated in FIGS. 12-13.

It will be appreciated that the alternative embodiments of the disclosure illustrated in FIGS. 12 and 13 may contain many of the same structures represented in FIGS. 1-11 and only the new or different structures will be explained to most succinctly explain the features which come with the embodiments of the disclosure illustrated in FIGS. 12 and 13.

FIG. 12 illustrates a perspective view of an alternative embodiment auxiliary eyewear 12b which attaches to the eyewear 10b from below, similarly to the embodiment of FIG. 11. However, the embodiment of FIG. 12 may include a support or connector 52b which may extend from a side of the temple extension 18b. The connector 52b may include a neck or brace portion 54b for attaching to the temple extension 18b in any manner known to those skilled in the art. The connector 52b may also include a magnet receptor portion 56b. The brace portion 54b may include a rod defining a neck between the second portion 19b of the temple extension 18b and the magnet receptor portion 56b. The magnet receptor portion 56b may define a cylinder for receiving the auxiliary magnet 48b therein. It will be understood that the magnet receptor portion 56b may or may not include a magnet for attaching to the auxiliary eyewear 12b.

It will be understood that the support 52b may be configured such that the tabs 46b may be positionable in the slots 32b defined between the support 52b and the temple extension 18b when the auxiliary eyewear 12b is attached to the eyewear 10b such that the tabs 46b may abut against the support 52b in the front to back direction 23. In other words, the tabs 46b may be configured to contact the supports 52b as the tabs 46b are moved in the front to back direction 23. The contact between the supports 52b and the tabs 46b may be configured to block further rearward movement of the tabs 46b with respect to the supports 56b.

As shown in FIG. 13, an additional alternative embodiment of the present disclosure may be provided in which the auxiliary eyewear 12c may be joined to the eyewear 10c from above, and the tab 46c may be attached to the connector 52c. Accordingly, the arms 44c may be configured to extend over a top of the temple extensions 18c when the auxiliary eyewear 12c is attached to the eyewear 10c.

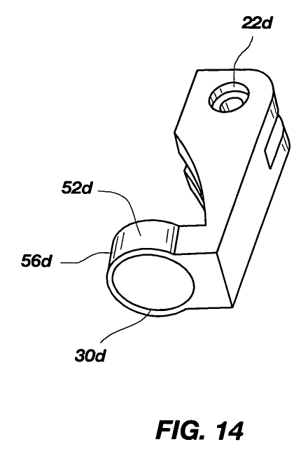

Reference will now to made to FIGS. 14-16 to describe additional alternative embodiments of the present disclosure. As previously discussed, the presently disclosed embodiments of the disclosure illustrated herein are merely exemplary of the possible embodiments of the disclosure, including those illustrated in FIGS. 14-16.

It will be appreciated that the alternative embodiments of the disclosure illustrated in FIGS. 14-16 may contain many of the same structures represented in FIGS. 1-13 and only the new or different structures will be explained to most succinctly explain the features which come with the embodiments of the disclosure illustrated in FIGS. 14-16.

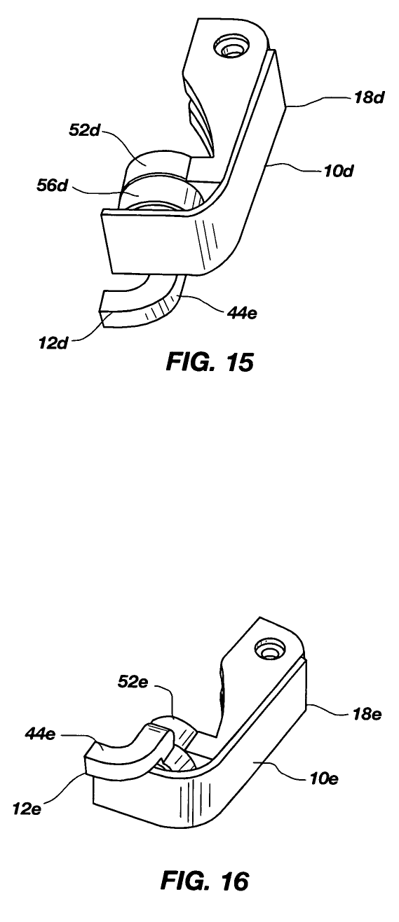

FIG. 14 illustrates a perspective view of an alternative embodiment support or connector 52d. The connector 52d may include a hinge 22d and a magnet receptor 56d that may be formed in a single piece. The connector 52d may be formed in a mold, for example, and the magnet 30d may be joined to the magnet receptor 56d in any manner known to those skilled in the art. The connector 52d may then be joined with the temple extension 18d as shown in FIGS. 15 and 16. Any suitable connecting mechanism, such as welding or adhesives, for example, may be used to join the connector 52d with the temple extension 18d. As shown in FIG. 15, the auxiliary eyewear 12d may be attached to the connector 52d from below. Alternatively, as shown in FIG. 16 the auxiliary eyewear 12e may be attached to the connector 52e from above.

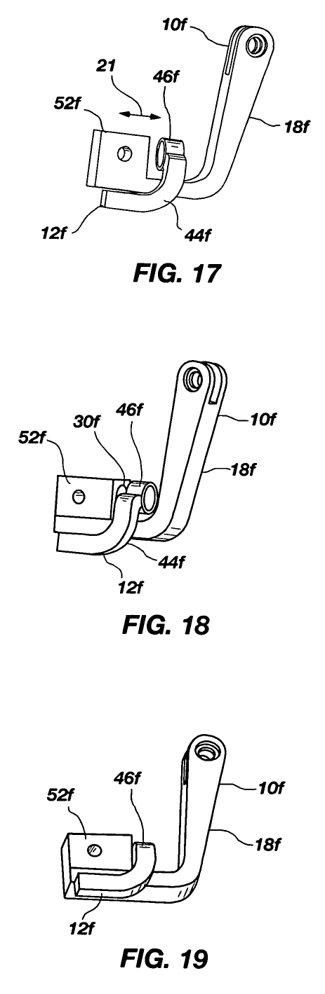

Reference will now to made to FIGS. 17-25 to describe additional alternative embodiments of the present disclosure. As previously discussed, the presently disclosed embodiments of the disclosure illustrated herein are merely exemplary of the possible embodiments of the disclosure, including those illustrated in FIGS. 17-25.

It will be appreciated that the alternative embodiments of the disclosure illustrated in FIGS. 17-25 may contain many of the same structures represented in FIGS. 1-16 and only the new or different structures will be explained to most succinctly explain the features which come with the embodiments of the disclosure illustrated in FIGS. 17-25.

FIGS. 17-19 illustrate a perspective view of an alternative embodiment support or connector 52f. The auxiliary eyewear 12f is separated from the eyewear 10f in FIGS. 17 and 18, whereas FIG. 19 depicts the auxiliary eyewear 12f connected to the eyewear 10f. The alternative embodiment connector 52f may be configured to attach to the tab 46f on a lateral side such that the tabs 46f may be positionable to abut the connector 52f or magnets 30f in the lateral direction 21 when the auxiliary eyewear 12f is attached to the eyewear 10f. Accordingly, lateral movement of the auxiliary eyewear 12f may be prevented by contact with the connector 52f as well as by a magnetic force. Magnetic attraction forces may also be utilized to prevent movement of the eyewear 12f in other directions. Moreover, the arms 44f may be supported over or on the temple extensions 18f, or other embodiments may allow the arms 44f to be attached to the connectors 18f from beneath the eyewear 10f.

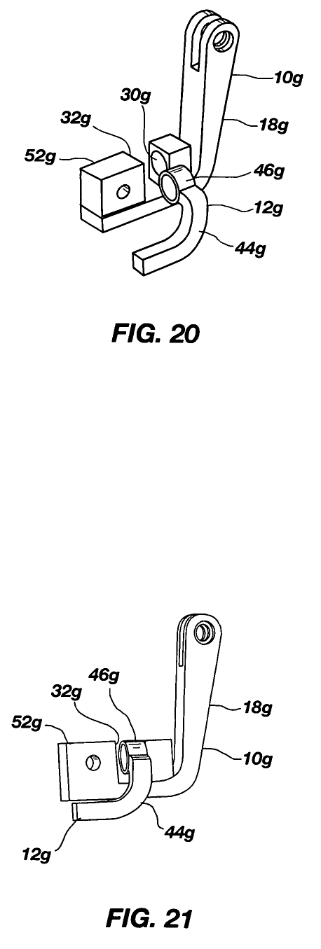

Referring to FIGS. 20 and 21, an additional alternative embodiment is shown in which a connector 52g may be provided to attach the tabs 46g of auxiliary eyewear 12g on a lateral side of the connector 52g. It will be understood that FIG. 20 depicts the auxiliary eyewear 12g disconnected from the eyewear log, whereas FIG. 21 depicts the auxiliary eyewear 12g attached to the eyewear 10g.

It will be understood that the connector 52g may include a slot 32g formed therein, and magnets 30g may or may not be disposed in the connector 52g for being joined with the tab 46g on the auxiliary eyewear 12g. It will be understood that magnets 30g may be disposed on either side of the slot 32g.

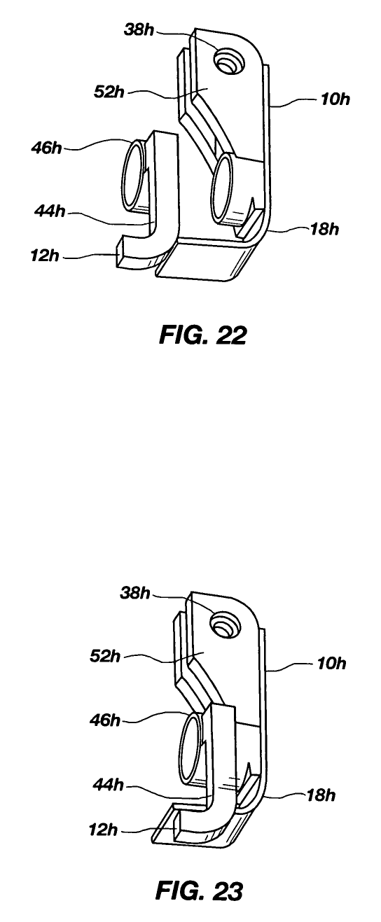

Another alternative embodiment of the present disclosure for providing a lateral connection between auxiliary eyewear 12h and eyewear 10h is presented in FIGS. 22 and 23. It will be understood that the auxiliary eyewear 12h is disconnected from the eyewear 10h in FIG. 22, whereas the auxiliary eyewear 12h is connected to the eyewear 10h in FIG. 23. The embodiment of the disclosure presented in FIGS. 22 and 23 may include a connector 52h that may be formed with a hinge 38h and a receptor portion 56h similar to the embodiment of FIGS. 14-16. The connector 52h may be attached to the temple extension 18h in any manner known to those skilled in the art. It will be understood that tabs 46h may be attachable to magnet receptor portions 56h of the connector 52h to thereby attach the auxiliary eyewear 12h to the eyewear 10h.

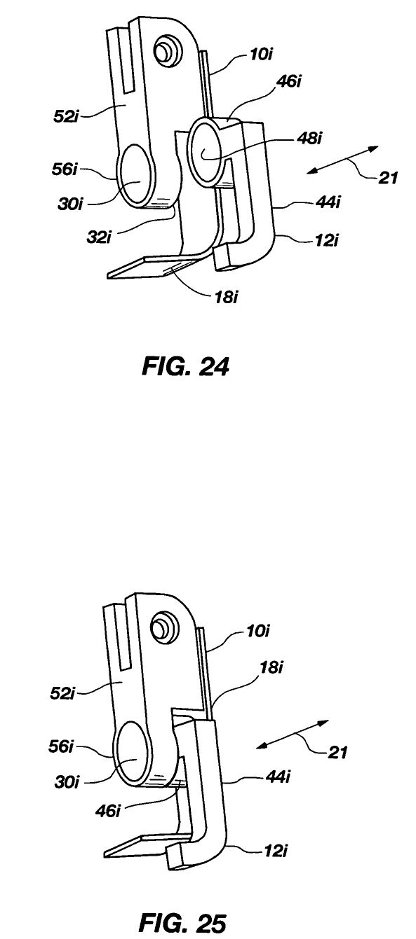

Referring now to FIGS. 24 and 25, an additional alternative embodiment of the present disclosure is shown for attaching auxiliary eyewear 12i to eyewear 10i. It will be understood that the auxiliary eyewear 12i is disconnected from the eyewear 10i in FIG. 24, and the auxiliary eyewear 12i is connected to the eyewear 10i in FIG. 25. The eyewear 10i may include a support or connector 52i that may include a slot 32i for receiving a tab 46i and connecting to the tab 46i in a lateral direction. The connector 52i may be attached on a lateral side of the temple extension 18i in any manner known to those skilled in the art. The slot 32i may be positioned between a magnet receptor 56i of the connector 52i and the temple extension 18i, or alternatively, the slot 32i may be bounded by the connector 52i on opposing sides.

The embodiment of FIGS. 24 and 25 may be configured such that the tabs 46i may be positionable in the slots 32i when the auxiliary eyewear 12i is attached to the eyewear 10i such that the tabs 46i abut against the supports 52i as the tabs 46i move in the lateral direction 21 and the auxiliary magnets 48i are joined with the magnets 30i.

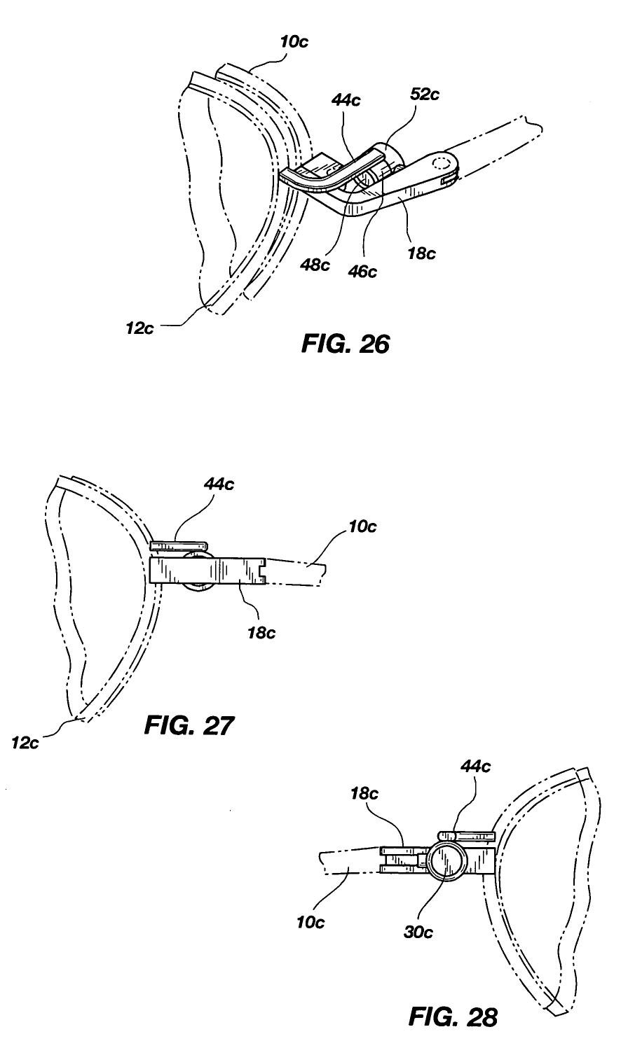

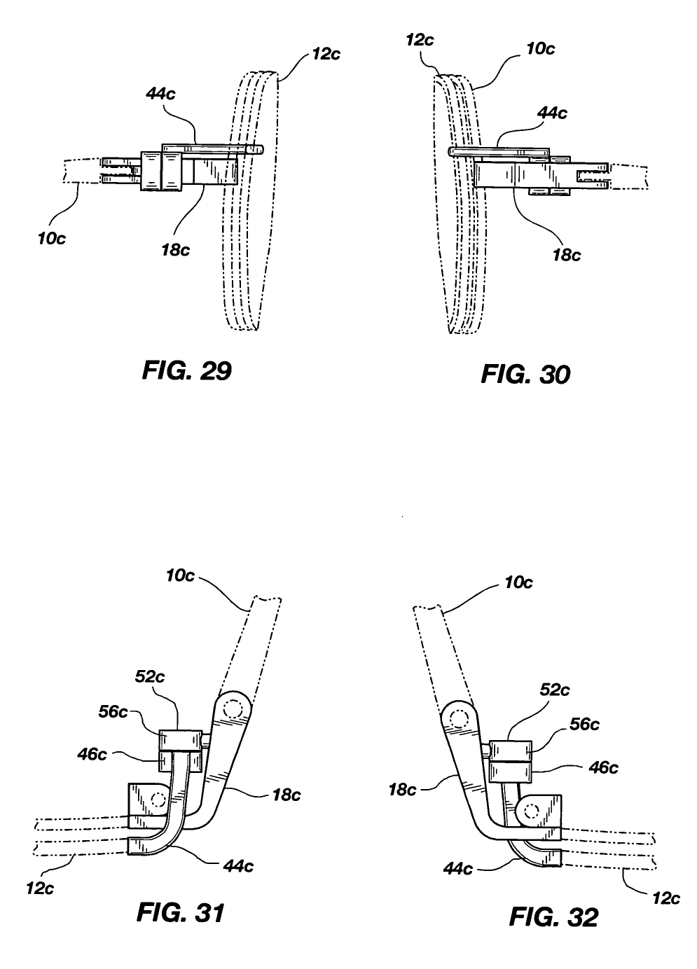

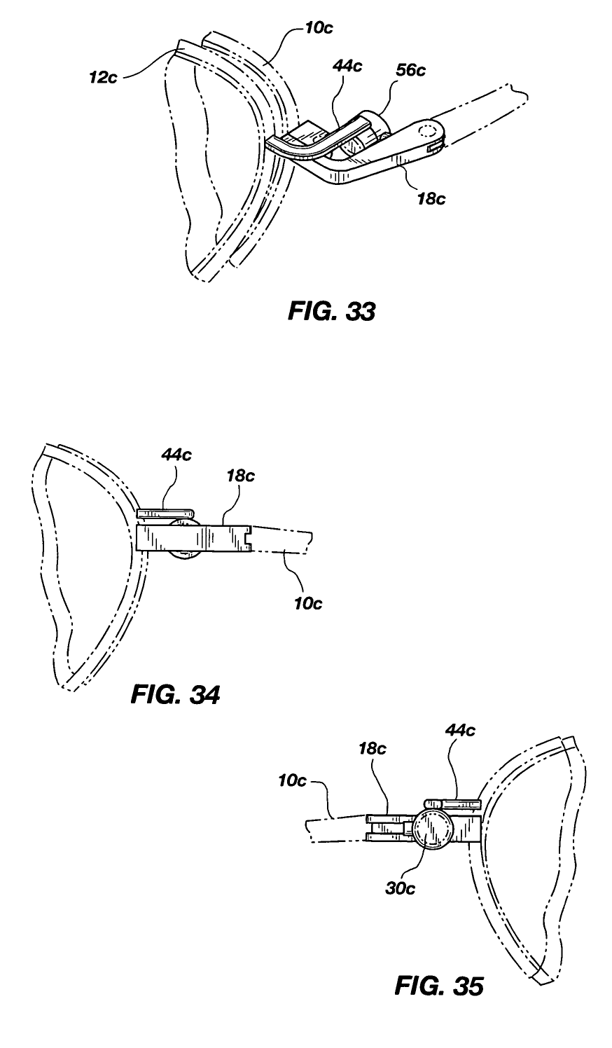

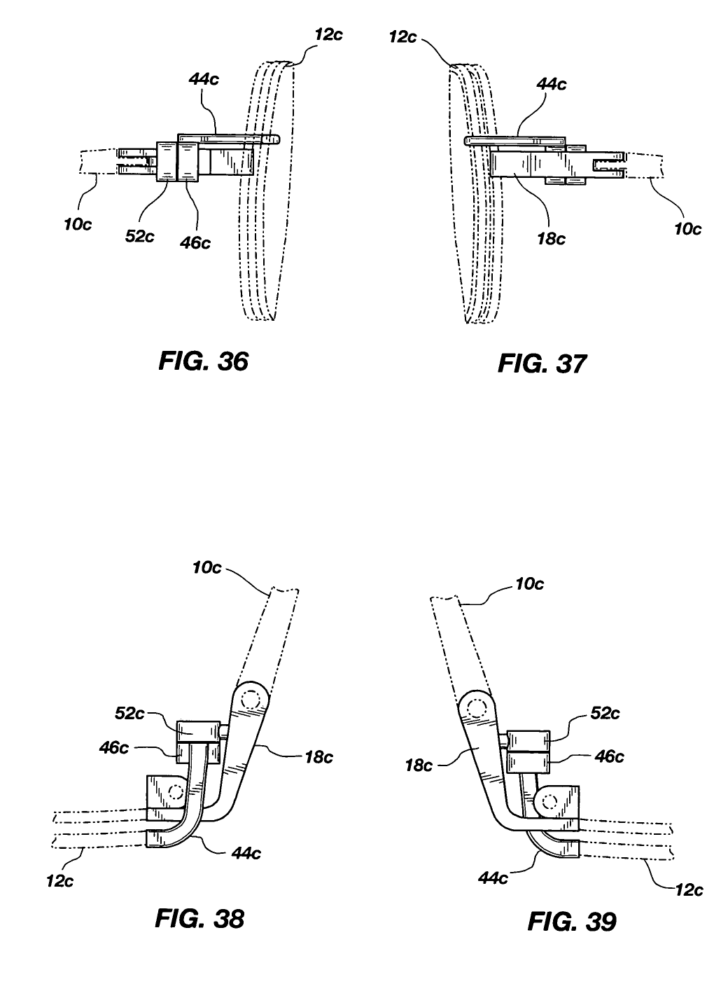

Referring now to FIGS. 26-32, various different views are shown of the embodiment of the present disclosure previously discussed with reference to FIG. 13, showing additional portions of the eyewear 10c and auxiliary eyewear 12c in dashed lines. Similarly, as shown in FIGS. 33-39, various different views are shown of the embodiment of FIG. 13 in which the magnet 30c is shown in dashed lines.

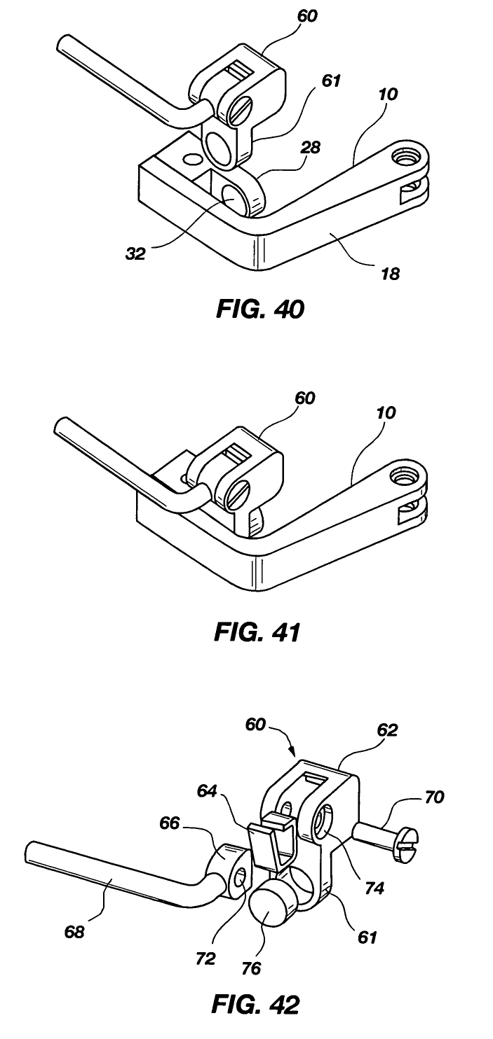

Reference will now be made to FIG. 40 to describe an alternative embodiment of the present disclosure. As previously discussed, the presently disclosed embodiments of the disclosure illustrated herein are merely exemplary of the possible embodiments of the disclosure, including that illustrated in FIG. 40.

It will be appreciated that the alternative embodiment of the disclosure illustrated in FIG. 40 may contain many of the same structures represented in FIGS. 1-39 and only the new or different structures will be explained to most succinctly explain the features which come with the embodiments of the disclosure illustrated in FIG. 40.

FIG. 40 illustrates an exploded, break-away perspective view of an adjustable connection 60 for attaching auxiliary eyewear to eyewear 10. The adjustable connection 60 may be configured to allow the auxiliary eyewear to be adjusted from a lowered position in which the auxiliary eyewear covers the eyewear, to a raised position in which the auxiliary eyewear may not cover the eyewear, while the auxiliary eyewear remains attached to the eyewear. The adjustable connection 60 may be useful for auxiliary eyewear, such as sunglasses, that may be lowered when a person is outdoors in a bright environment to protect the persons eyes against bright sunlight for example. If the person desires to see through the eyewear without the effects of the auxiliary eyewear, such as if the person enters a darkened environment, the person may simply raise or “flip” the auxiliary eyewear up while the auxiliary eyewear remains on the eyewear. As shown in FIG. 40, the eyewear 10 may include a support 28 and temple extension 18 as previously described. However, it will be understood that the adjustable connection 60 may be configured to be compatible with eyewear having various different configurations. For example, the adjustable connection 60 may be compatible with a support 28 joined with the first portion 17 of the temple extension 18, or the adjustable connection 60 may be compatible with a support 28 joined with the second portion 19 of the temple extension 18.

The adjustable connection 60 may include a tab 61 that may be receivable in the slot 32 in a manner similar to the previously disclosed embodiments, as shown in most clearly in FIG. 41, which shows a breakaway perspective view of the adjustable connection 60 joined with the eyewear 10.

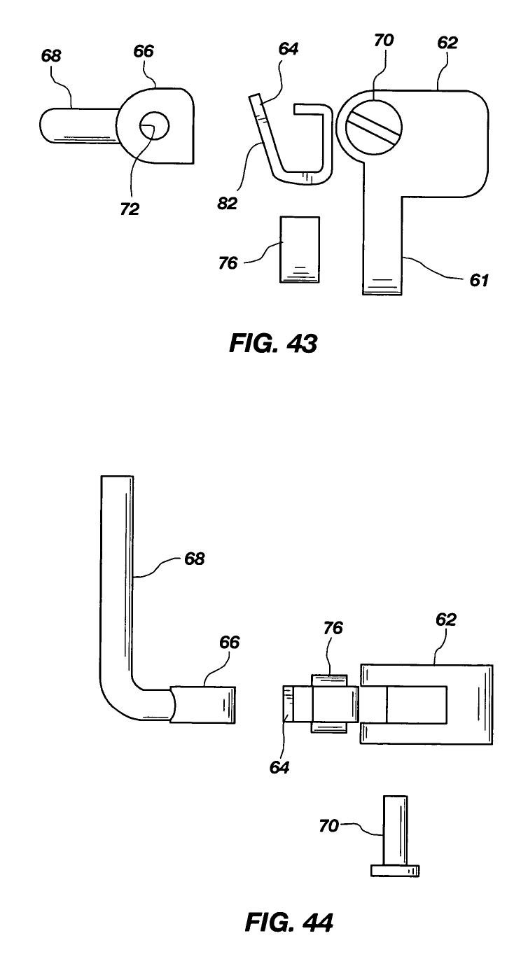

An exploded perspective view of the adjustable connection 60 is shown in FIG. 42. The adjustable connection 60 may include a housing 62 for receiving a biasing member 64 and a joint 66. The joint 66 may be joined with an arm 68 of the auxiliary eyewear, and the joint 66 may be attached to the housing 62 by a fastener 70. The joint 66 may include an bore 72 for receiving the fastener 70 such that the joint 66 and arm 68 may be allowed to rotate about the fastener 70. It will be understood that the fastener 70 may be formed as a pin, rod, bolt, or any other suitable attaching mechanism. The housing 62 may also include an opening 74 for receiving the fastener 70. Moreover, a magnet 76 may be joined with the tab 61 for providing attractive forces for connecting to the support 28. It will be understood that an exploded side view of the adjustable connection 60 is shown in FIG. 43, and an exploded top view of the adjustable connection 60 is shown in FIG. 44.

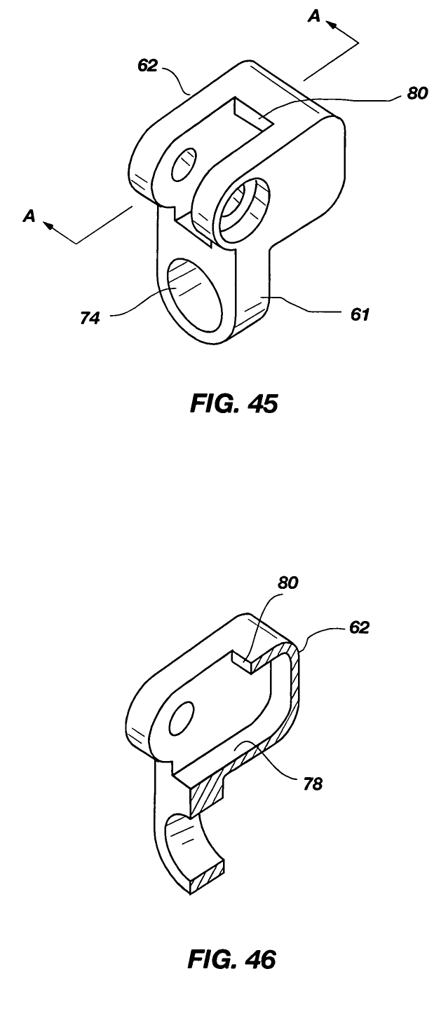

Referring to FIG. 45, a perspective view of one embodiment of the housing 62 is shown. A perspective cross-sectional view of the housing 62, as taken from line A-A in FIG. 45, is shown in FIG. 46. The housing 62 may include a chamber 78 for receiving the biasing member 64 and joint 66. The housing 62 may also include a slot 80 joining with the chamber 78 to allow the joint 66 and arm 68 to move with respect to the housing 62. It will be understood that the chamber 78 and slot 80 may have various different configurations, and other embodiments of the present disclosure may be formed without the chamber and/or the slot 80.

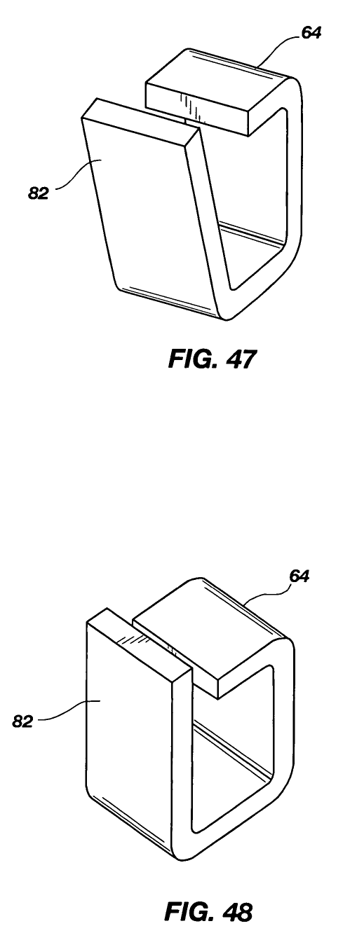

Referring to FIGS. 47 and 48, perspective views of one embodiment of the biasing member 64 are shown. It will be understood that FIG. 47 depicts the biasing member 64 in a relaxed condition, whereas FIG. 48 depicts the biasing member in a compressed condition. One embodiment of the biasing member 64 may include an abutting surface 82 that may be substantially planar and configured to contact a surface of the joint 66 to hold the joint in either a lowered or raised position under the biasing force of the biasing member 64. It will be understood, that the biasing member may have various different configurations within the scope of the present disclosure. Moreover, it will be understood that the biasing member 64 may be formed of various different suitable resilient materials configured for providing a biasing force. It will also be understood that other embodiments of the present disclosure may be formed without a biasing member 64.

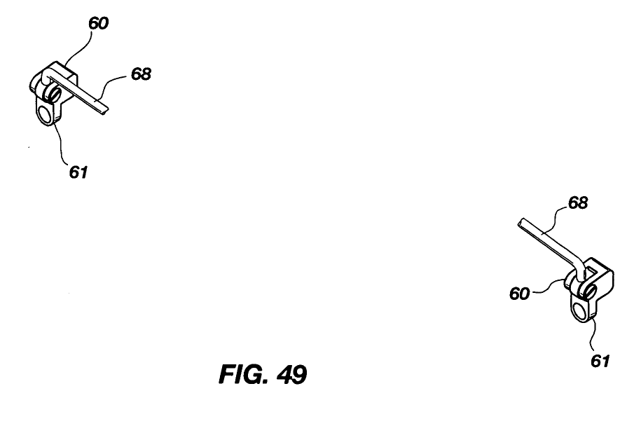

Referring to FIG. 49, a break-away perspective view is shown of opposing adjustable connections 60 with the arms 68 in a raised position. It will be understood that the force provided by the biasing member 64 may allow the arms 68 to remain in the raised position until a force is applied to the auxiliary eyewear to overcome the force provided by the biasing member 64.

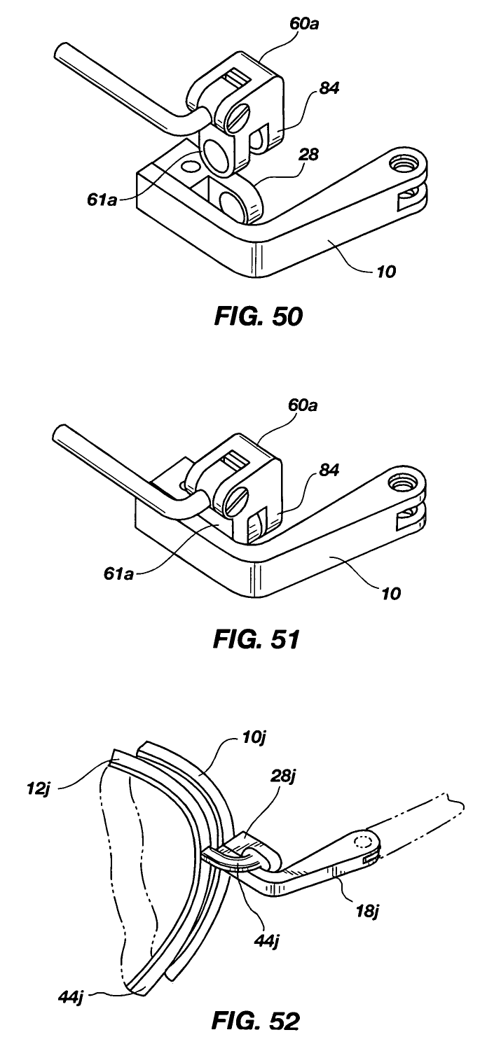

Referring now to FIGS. 50 and 51, an additional alternative embodiment of the present disclosure is shown. As previously discussed, the presently disclosed embodiments of the disclosure illustrated herein are merely exemplary of the possible embodiments of the disclosure, including that illustrated in FIGS. 50 and 51.

It will be appreciated that the alternative embodiment of the disclosure illustrated in FIGS. 50 and 51 may contain many of the same structures represented in FIGS. 1-49 and only the new or different structures will be explained to most succinctly explain the features which come with the embodiments of the disclosure illustrated in FIGS. 50 and 51.

FIG. 50 discloses an exploded perspective view of an alternative embodiment adjustable connector 60a and a portion of the eyewear 10. The alternative embodiment adjustable connector 60a is depicted attached to the eyewear in FIG. 51. The alternative embodiment adjustable connector 60a may include a second tab 84 such that the tab 61a and the second tab 84 may be configured to receive a portion of the support 28 therebetween to provide additional support against torsional forces applied by moving the auxiliary eyewear between the raised and lowered positions. It will be understood that the second tab 84 may or may not include a magnet, and that the second tab 84 may have various different configurations within the scope of the present disclosure.

Reference will now be made to FIG. 52 to describe another alternative embodiment of the present disclosure. As previously discussed, the presently disclosed embodiments of the disclosure illustrated herein are merely exemplary of the possible embodiments of the disclosure, including that illustrated in FIG. 52.

It will be appreciated that the alternative embodiment of the disclosure illustrated in FIG. 52 may contain many of the same structures represented in FIGS. 1-51 and only the new or different structures will be explained to most succinctly explain the features which come with the embodiments of the disclosure illustrated in FIG. 52.

FIG. 52 illustrates a break-away perspective view of an alternative embodiment auxiliary eyewear 12j joined to eyewear 10j in which an arm 44j extends from a side of the auxiliary eyewear frame 34j, without projecting from a front of the frame 34j. It will be understood that the configuration of the disclosure of FIG. 52 may provide strength and manufacturing benefits as compared to other embodiments.

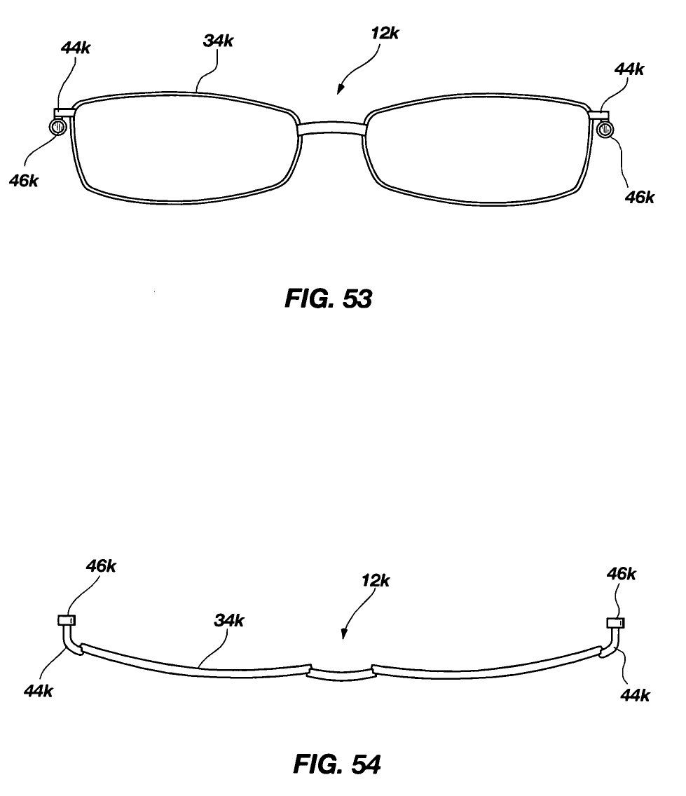

Reference will now be made to FIGS. 53-60 to describe an additional alternative embodiment of the present disclosure. As previously discussed, the presently disclosed embodiments of the disclosure illustrated herein are merely exemplary of the possible embodiments of the disclosure, including that illustrated in FIGS. 53-60.

It will be appreciated that the alternative embodiment of the disclosure illustrated in FIGS. 53-60 may contain many of the same structures represented in FIGS. 1-52 and only the new or different structures will be explained to most succinctly explain the features which come with the embodiments of the disclosure illustrated in FIGS. 53-60.

FIG. 53 illustrates a front view of an alternative embodiment auxiliary eyewear, indicated generally at 12k. A top view of the auxiliary eyewear 12k is shown in FIG. 54. The auxiliary eyewear 12k may include arms 44k and tabs 46k similar to the previously disclosed embodiment of FIG. 13, for example. However, the auxiliary eyewear 12k may include a frame 34k having a different design. It will be understood that the auxiliary eyewear 12k may have various different shapes and configurations within the scope of the present disclosure.

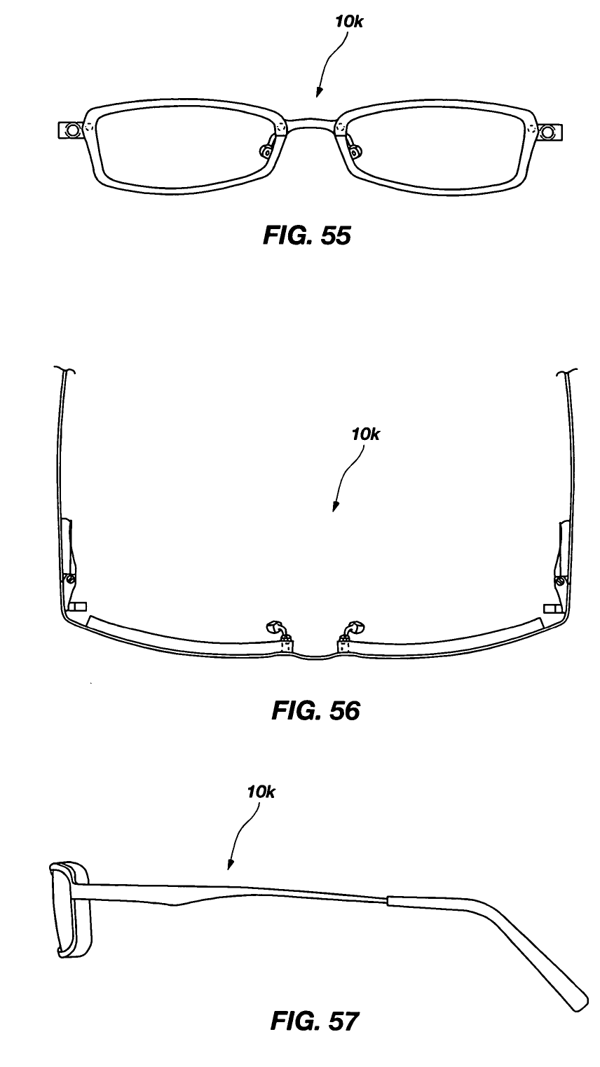

A front view of a pair of eyewear, indicated generally at 10k, is shown in FIG. 55, corresponding to the auxiliary eyewear 12k. A break-away top view of the eyewear 10, is shown in FIG. 56, and a side view of the eyewear 10k is shown in FIG. 57. As previously indicated, it will be understood that the shape, size and configuration of the eyewear 10k may vary within the principles of the present disclosure.

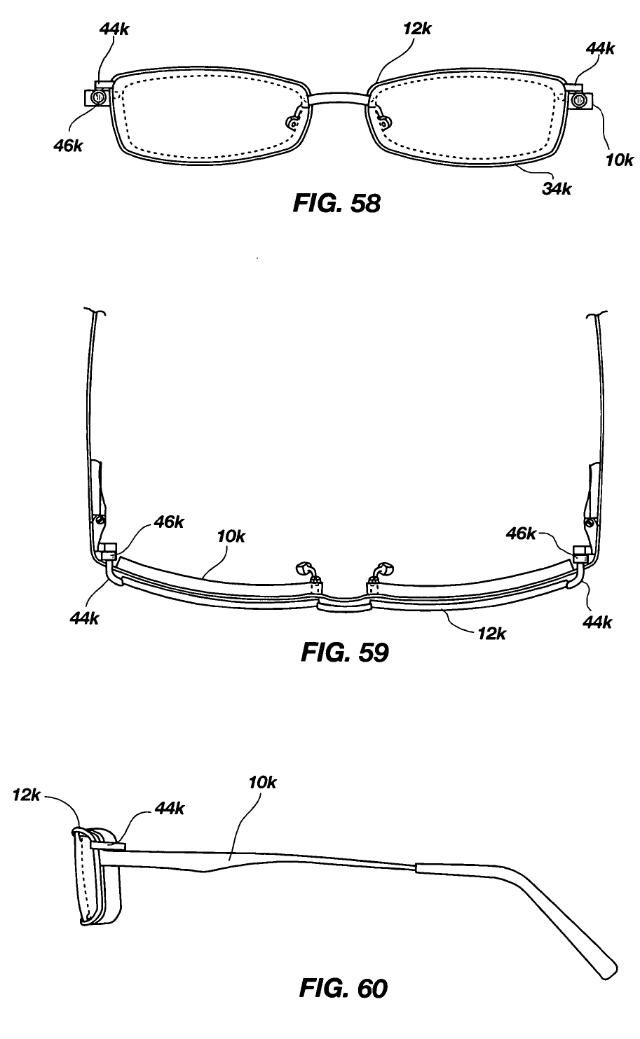

The auxiliary eyewear 12k may be joined with the eyewear 10 as shown in FIGS. 58-60. FIG. 58 shows a front view of the auxiliary eyewear 12k joined to the eyewear 10k. FIG. 59 depicts a break-away top view of the auxiliary eyewear 12k joined to the eyewear 10k, and FIG. 60 shows a side view of the auxiliary eyewear 12k joined to the eyewear 10k.

It will be understood that the various embodiments of eyewear 10 and auxiliary eyewear 12 disclosed herein may be made of various suitable materials known to those skilled in the art. Moreover, any suitable method of manufacturing the eyewear 10 and auxiliary eyewear 12, known to those skilled in the art, may be used within the scope of the present disclosure.

In accordance with the features and combinations described above, a useful method of joining auxiliary eyewear to eyewear may include the steps of:

(a) providing a support on the eyewear, the support defining a slot;

(b) providing an arm and a tab extending from an end of the arm on the auxiliary eyewear;

(c) providing a magnet on at least one of the support and the tab; and

(d) inserting the tab in the slot.

Those having ordinary skill in the relevant art will appreciate the advantages provide by the features of the present disclosure. For example, it is a feature of the present disclosure to provide eyewear and auxiliary eyewear which are simple in design and manufacture. Another feature of the present disclosure is to provide eyewear which facilitate attachment of auxiliary eyewear. It is a further feature of the present disclosure, in accordance with one aspect thereof, to provide a mechanism for securely holding auxiliary eyewear to eyewear. It is another feature of the present disclosure to provide an adjustable connection to allow auxiliary eyewear to be attached to eyewear in which the auxiliary eyewear can be adjusted from raised to lowered positions.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. An apparatus comprising:
eyewear including lens receptacles for receiving lenses, said eyewear further comprising temple extensions on opposing sides of said lens receptacles, said temple extensions each comprising a first portion extending in a lateral direction with respect to said lens receptacles and a second portion extending transverse to said first portion in a front to back direction, said eyewear further comprising supports extending from said second portion of each of said temple extensions, each of said supports comprising a magnet and defining a slot between said supports and said first portion of said temple extensions;
auxiliary eyewear removably attachable to said eyewear, said auxiliary eyewear including an auxiliary frame having arms on opposite sides and a tab on each of said arms;
wherein said tabs are positionable in said slots when said auxiliary eyewear is attached to said eyewear such that said tabs abut against said supports in said front to back direction.

2. The apparatus of claim 1, wherein each tab comprises an auxiliary magnet.

3. The apparatus of claim 1, wherein said arms are configured to extend over a top of said temple extensions when said auxiliary eyewear is attached to said eyewear.

4. The apparatus of claim 1, wherein said tabs are configured on said arms such that said tabs are positionable in said slots from beneath said eyewear.

5. The apparatus of claim 1, wherein each support forms part of a connecter comprising a hinge, said connector being attachable to said second portion of said temple extension.

6. The apparatus of claim 1, wherein each support comprises a brace portion for attaching to said second portion of said temple extension, and a magnet receptor portion.

7. The apparatus of claim 1, wherein said arms extend from each of said opposite sides of said auxiliary frame without extending from a front side of said auxiliary frame.

8. An apparatus comprising:
eyewear including lens receptacles for receiving lenses, said eyewear further comprising temple extensions on opposing sides of said lens receptacles, said temple extensions each comprising a first portion extending in a lateral direction with respect to said lens receptacles and a second portion extending transverse to said first portion in a front to back direction, said eyewear further comprising supports extending from said second portion of each of said temple extensions, each of said supports comprising a magnet and defining a slot between said supports and said second portion of said temple extensions;
auxiliary eyewear removably attachable to said eyewear, said auxiliary eyewear including an auxiliary frame having arms on opposite sides and a tab on each of said arms;
wherein said tabs are positionable in said slots when said auxiliary eyewear is attached to said eyewear such that said tabs abut against said supports in said lateral direction.

9. The apparatus of claim 8, wherein each tab comprises an auxiliary magnet.

10. The apparatus of claim 8, wherein said arms are configured to extend over a top of said temple extensions when said auxiliary eyewear is attached to said eyewear.

11. The apparatus of claim 8, wherein each support forms part of a connecter comprising a hinge, said connector being attachable to said second portion of said temple extension.

12. The apparatus of claim 8, wherein said arms extend from each of said opposite sides of said auxiliary frame without extending from a front side of said auxiliary frame.

13. The apparatus of claim 8, wherein said arms comprise a polygonal cross-sectional configuration.

14. The apparatus of claim 8, wherein said slot is positioned between said magnet and said second portion of said temple extension.

15. An apparatus comprising:
eyewear including lens receptacles for receiving lenses, said eyewear further comprising temple extensions on opposing sides of said lens receptacles, said temple extensions each comprising a first portion extending in a lateral direction with respect to said lens receptacles and a second portion extending transverse to said first portion in a front to back direction, said eyewear further comprising supports extending from said temple extensions, each of said supports comprising a magnet and defining a slot between said supports and said temple extensions; and
auxiliary eyewear removably attachable to said eyewear, said auxiliary eyewear including an auxiliary frame for holding auxiliary lenses, said auxiliary eyewear having a front side, a back side and opposing lateral sides, said auxiliary eyewear further comprising an arm extending from each of said opposing lateral sides of said auxiliary frame without extending from said front side of said auxiliary frame, and a tab on each of said arms;
wherein said tabs are positionable in said slots when said auxiliary eyewear is attached to said eyewear such that said tabs abut against said supports in said front to back direction.

16. The apparatus of claim 15, wherein each tab comprises an auxiliary magnet.

17. The apparatus of claim 15, wherein said arms are configured to extend over a top of said temple extensions when said auxiliary eyewear is attached to said eyewear.

18. The apparatus of claim 15, wherein said tabs are configured on said arms such that said tabs are positionable in said slots from beneath said eyewear.

19. The apparatus of claim 15, wherein said arms comprise a polygonal cross-sectional configuration.

20. The apparatus of claim 15, wherein said support extends from said first portion of said temple extension.

21. The apparatus of claim 15, wherein said slot is positioned between said magnet and said first portion of said temple extension.

22. An apparatus comprising:
eyewear including lens receptacles for receiving lenses, said eyewear further comprising temple extensions on opposing sides of said lens receptacles, said temple extensions each comprising a first portion extending in a lateral direction with respect to said lens receptacles and a second portion extending transverse to said first portion in a front to back direction, said eyewear further comprising supports extending from said first portion of each of said temple extensions, said supports comprising magnets;
auxiliary eyewear removably attachable to said eyewear, said auxiliary eyewear including an auxiliary frame having arms on opposite sides and a tab on each of said arms;
wherein said tabs are positionable to abut said magnets in said lateral direction when said auxiliary eyewear is attached to said eyewear.

23. The apparatus of claim 22, wherein each tab comprises an auxiliary magnet.

24. The apparatus of claim 22, wherein said arms are configured to extend over a top of said temple extensions when said auxiliary eyewear is attached to said eyewear.

25. The apparatus of claim 22, wherein said arms extend from each of said opposite sides of said auxiliary frame without extending from a front side of said auxiliary frame.

26. The apparatus of claim 22, wherein each of said supports comprise a slot for receiving a tab therein.

27. The apparatus of claim 22, wherein each of said supports define a slot between said support and said second portion of said temple extension.

28. An apparatus comprising:
eyewear including lens receptacles for receiving lenses, temple extensions on opposing sides of said lense receptacles, and supports on each of said temple extensions, each of said supports defining a slot with respect to a portion of said temple extensions;
auxiliary eyewear removably attachable to said eyewear through an adjustable connection such that said auxiliary eyewear is configured to be adjusted between a raised position and a lowered position;
wherein said adjustable connection comprises a housing having a wall defining a chamber for receiving a biasing member therein, said wall having a lower surface and a tab projecting from said lower surface, said tab being receivable in said slot when said auxiliary eyewear is attached to said eyewear.

29. The apparatus of claim 28, wherein said biasing member comprises a substantially planar surface for holding said auxiliary eyewear in one of said raised and lowered positions.

30. The apparatus of claim 28, wherein said tab comprises an auxiliary magnet.

31. The apparatus of claim 28, wherein said auxiliary eyewear comprises an auxiliary frame having arms extending on opposite sides.

32. The apparatus of claim 28, wherein said arms are configured to extend above said temple extensions when said auxiliary eyewear is attached to said eyewear.

33. The apparatus of claim 28, wherein said arms extend from each of said opposite sides of said auxiliary frame without extending from a front side of said auxiliary frame.

34. The apparatus of claim 28, wherein said temple extensions each comprise a first portion extending in a lateral direction with respect to said lens receptacles and a second portion extending transverse to said first portion in a front to back direction.

35. The apparatus of claim 28, wherein said support extends from said first portion of said temple extension.

36. An apparatus comprising:
eyewear including lens receptacles for receiving lenses, temple extensions on opposing sides of said lense receptacles, and supports on each of said temple extensions, each of said supports defining a slot with respect to a portion of said temple extensions;
auxiliary eyewear removably attachable to said eyewear through an adjustable connection such that said auxiliary eyewear is configured to be adjusted between a raised position and a lowered position;
wherein said adjustable connection comprises a biasing member having a surface for holding said auxiliary eyewear in one of said raised and lowered positions.

37. The apparatus of claim 36, wherein said biasing member is substantially planar.

38. The apparatus of claim 36, further comprising a tab projecting from a lower surface of said housing.

39. The apparatus of claim 36, wherein said tab comprises an auxiliary magnet.

40. The apparatus of claim 36, wherein said auxiliary eyewear comprises an auxiliary frame having arms extending on opposite sides.

41. The apparatus of claim 36, wherein said arms are configured to extend over a top of said temple extensions when said auxiliary eyewear is attached to said eyewear.

42. The apparatus of claim 36, wherein said arms extend from each of said opposite sides of said auxiliary frame without extending from a front side of said auxiliary frame.

43. The apparatus of claim 36, wherein said temple extensions each comprise a first portion extending in a lateral direction with respect to said lens receptacles and a second portion extending transverse to said first portion in a front to back direction.

44. The apparatus of claim 36, wherein said support extends from said first portion of said temple extension.

45. The apparatus of claim 36, wherein said support extends from said second portion of said temple extension.

46. The apparatus of claim 36, wherein said adjustable connection comprises a housing having a wall defining a chamber for receiving said biasing member.

47. An apparatus comprising:
eyewear including lens receptacles for receiving lenses, said eyewear further comprising temple extensions on opposing sides of said lens receptacles, said temple extensions each comprising a first portion extending in a lateral direction with respect to said lens receptacles and a second portion extending transverse to said first portion in a front to back direction, said eyewear further comprising supports extending from said second portion of each of said temple extensions, each of said supports comprising a magnet and defining a slot between said supports and said first portion of said temple extensions;
auxiliary eyewear removably attachable to said eyewear, said auxiliary eyewear including an auxiliary frame having arms on opposite sides and a tab on each of said arms;
wherein said tabs are positionable in said slots when said auxiliary eyewear is attached to said eyewear such that said tabs abut against said supports to prevent movement of said auxiliary eyewear with respect to said eyewear in said front to back direction;
wherein each tab comprises a cylinder and an auxiliary magnet received therein;
wherein said arms are configured to extend over a top of said temple extensions when said auxiliary eyewear is attached to said eyewear;
wherein each support comprises a brace portion for attaching to said second portion of said temple extension, and a magnet receptor portion, said brace portion comprising a rod defining a neck between said second portion of said temple extension and said magnet receptor portion, said magnet receptor portion defining a cylinder for receiving said magnet therein;
wherein said arms extend from each of said opposite sides of said auxiliary frame without extending from a front side of said auxiliary frame.

48. An apparatus comprising:
eyewear including lens receptacles for receiving lenses, temple extensions on opposing sides of said lense receptacles, and supports on each of said temple extensions, each of said supports comprising a magnet and defining a slot with respect to a portion of said temple extensions;
auxiliary eyewear comprising an auxiliary frame having arms extending on opposite sides, said auxiliary eyewear being removably attachable to said eyewear through an adjustable connection disposed on each of said arms such that said auxiliary eyewear is configured to be adjusted between a raised position and a lowered position;
wherein each of said adjustable connections comprise a housing having a wall defining a chamber receiving a biasing member therein, said wall having a lower surface and a tab projecting from said lower surface, said tabs being receivable in said slots when said auxiliary eyewear is attached to said eyewear;
wherein each of said biasing members comprises a substantially planar surface for holding said auxiliary eyewear in one of said raised and lowered positions;
wherein each of said tabs comprise an auxiliary magnet;
wherein said arms are configured to extend above said temple extensions when said auxiliary eyewear is attached to said eyewear;
wherein said temple extensions each comprise a first portion extending in a lateral direction with respect to said lens receptacles and a second portion extending transverse to said first portion in a front to back direction;
wherein each of said supports extend from one of said first portions of said temple extensions;
wherein each of said supports is configured such that said slots are defined between said supports and said first portions of said temple extensions;
wherein each of said arms comprises a joint attachable to the housing by a fastener, each of said joints comprising a bore for receiving said fastener therein such that said joints are configured to rotate about said fasteners;
wherein each of said housings comprise an opening for receiving said fasteners therethrough;
wherein each of said housings comprises a housing slot for allowing said arms and said joints to move with respect to said housings; and
wherein said substantially planar surfaces of said biasing members contact said joints to hold said auxiliary eyewear in one of said raised and lowered positions.
